(19) United States
(12) Patent Application Publication
(10) Pub. No.: US 2026/0244862 A1
(43) Pub. Date: Aug. 20, 2026

(54) Hierarchical Selection of Algorithms and Ontology Classes for Matching Terms to Agronomic Ontologies

(71) Applicant: GROWERS TECH INC. D.B.A. AGMATIX, St. Louis, MO (US)

(72) Inventors: Alon VAMOS, Jerusalem (IL); Uria LUZON; Tomer RAM, Netanya (IL); Sagi KATZ, Rehovot (IL)

(73) Assignee: GROWERS TECH INC. D.B.A. AGMATIX, St. Louis, MO (US)

(21) Appl. No.: 19/159,721

(22) PCT Filed: Sep. 12, 2024
(86) PCT No.: PCT/IL2024/050909

§ 371 Date: Aug. 26, 2025

Related U.S. Application Data
(60) Provisional application No. 63/582,869, filed on Sep. 15, 2023.

(51) Int. Cl. G06F 40/284

(52) U.S. Cl. CPC G06F 40/284

(57) ABSTRACT

A method for matching terminology within a document with terminology from a preexisting ontology is disclosed. The method includes: selecting a plurality of matching algorithms to apply to the document from a set of predetermined matching algorithms; establishing rules for application of the selected algorithms, the rules including: (1) a sequence of how many and which algorithms to apply in a hierarchy and (2) a degree of confidence required in order for each algorithm to output a match; applying the matching algorithms to the document; and based on the output of the matching algorithms, tagging the terms in the document with the corresponding terms in the preexisting ontology.

### FIELD OF THE INVENTION

The present invention relates to the field of matching ontologies, and more specifically, but not exclusively, to systems and methods for enabling selection from among different matching algorithms and ordering of ontology classes in order to match terms in the text to terms in a preexisting ontology.

### BACKGROUND OF THE INVENTION

Several factors can make identifying and comprehending parameters in agronomic research datasets challenging.

Diverse and Complex Data: Agricultural data encompasses a wide range of variables, including soil composition, weather conditions, crop types, pest populations, and farming practices. These parameters' sheer diversity and complexity make it difficult to standardize and interpret the data.

Heterogeneous Data Sources: Data in agriculture often comes from various sources such as field sensors, satellite imagery, weather stations, and manual records. These sources use different formats and units, requiring extensive preprocessing to integrate and analyze the data cohesively.

Temporal and Spatial Variability: Agricultural parameters can vary significantly over time and space. Factors such as seasonal changes, geographical differences, and microclimates add layers of variability that complicate the identification and analysis of parameters.

Interdisciplinary Knowledge: Understanding agricultural data often requires interdisciplinary knowledge, combining insights from agronomy, meteorology, biology, and environmental science. This complexity necessitates expertise in multiple domains to interpret the data accurately.

Noise and Uncertainty: Agricultural data is noisy and uncertain due to measurement errors, environmental factors, and biological variability. Distinguishing between meaningful signals and noise is crucial but challenging.

Dynamic and Evolving Conditions: Agricultural systems are dynamic and constantly changing. Parameters relevant in one season or location may not be applicable in another, requiring continuous adaptation and updates to data models.

Lack of Standardized Ontologies: The agricultural domain often lacks standardized ontologies and taxonomies that can be universally applied, making it difficult to categorize and interpret parameters across different studies and datasets consistently.

These challenges highlight the need for specialized tools and methodologies, including integrating advanced models with ontological systems, to enhance parameter identification and comprehension accuracy and efficiency in agricultural research.

Ontology alignment serves to determine when an entry in one ontology is semantically related to an entry in a different ontology. Ontology alignment enables meaningful comparison of data that is organized based on the different ontological systems. Ontology alignment may be performed on entire structured ontologies, or on specific terms within a document. “Ontology matching,” refers to the specific challenge of assigning a term within a document to a corresponding term within a preexisting ontology. Ontology alignment and matching have been a focus of study in various fields that rely heavily on data, including anatomy, medicine, and nutrition.

Various algorithms are currently used for ontology matching. These algorithms typically analyze the match between different terms by considering the syntactic overlap (i.e., the degree of overlap between textual characters in the two terms) or the semantic similarity of the terms (i.e., how close the terms are in meaning). However, these algorithms are agnostic to the context in which a certain term is used. Ontology matching algorithms, while crucial for integrating and harmonizing data from different sources, face several key challenges such as:
1) Heterogeneity—Ontologies often differ in structure, terminology, granularity, and conceptualization. These differences make it hard to align concepts accurately, especially when different domains or organizations use varying definitions for the same terms.
2) Scalability—As ontologies grow in size and complexity, matching algorithms struggle with performance. Large-scale ontologies with thousands of classes and relationships require significant computational resources, and current algorithms may not scale efficiently.
3) Ambiguity and Inconsistency—Many terms in ontologies can be ambiguous, with multiple meanings depending on context. Algorithms often have difficulty determining the correct meaning or relationship, especially when the terms or classes are used inconsistently across different datasets.
4) Evaluation and Validation—Evaluating the quality of ontology matches can be subjective and context-dependent. There is no universally accepted standard for assessing the accuracy or correctness of matching results, making validation challenging.

This poses a significant challenge for ontology matching for interdisciplinary research such as agronomic research, where similar terms are used in the multiple, diverse disciplines associated with interdisciplinary research.

Furthermore, terminology in a specific field of research may display a hierarchical relationship or context. For example, in agronomic research, the terminology associated with “research” will also be associated with “trial,” because research involves performing multiple trials or experiments to test the validity of one or more hypotheses. New research aims to create knowledge and understanding regarding a given problem by creatively reconstituting existing knowledge. Therefore, a given set of trials may serve more than one research or hypothesis.

Terminology associated with “trial” will also be associated with “treatment,” because each trial or experiment systematically compares different treatments (i.e., agriculture production technologies and practices) on one or more relatively small plots of land. The terminology associated with “treatment” will also be associated with “plot,” because each treatment may be applied to a plurality of plots designated for the treatment.

The terminology associated with “plot” will also be associated with “sample” because multiple samples are obtained from each plot, where samples are ‘data points’ containing parameters that represent measured, assessed, or observed values.

By way of example, “in research project A (‘Research’ parameter) in country X (‘Trial’ parameter), fungicide applications were made (‘Treatment’ parameter) in orchard plot Y (‘Plot’ parameter), and for each of the applications, a Mega ton per Hectare yield (‘Sample’ parameter) was measured.

There is, therefore, a hierarchical context or relationship between terminology associated with the categories of “research”, “trial”, “treatment”, “plot”, and “sample,” with “research” being the parent of all the other categories and “sample” being the child of all the other categories. This hierarchical context is not visible to traditional ontology-matching algorithms.

Therefore, there is a need in the art for context-aware ontology matching.

### SUMMARY OF THE INVENTION

The present invention discloses an agronomic ontology called GUARDS (Growing Universal Agronomic Data Standard). Developing the GUARDS system requires collating agronomic data into a master agronomic database organized around the principles of the GUARDS ontology. This, in turn, requires matching the data and terminology with the corresponding terminology of the GUARDS ontology.

The present disclosure provides systems and methods for ontology matching, with a focus on ontology matching for agronomic terminology. In particular, the systems disclosed herein feature a hierarchical system for applying matching algorithms. Using the hierarchical system, the user is able to select which matching algorithms are applied to the agronomic terminology, and in which sequence. Using a suitable hierarchical arrangement for applying different matching algorithms, contest-aware ontology matching may be achieved. In addition, the user may set rules regarding the minimum degree of confidence required in order to establish a semantic match. As a result, the degree of accuracy and confidence in the results of the matching is higher.

In addition to selection of the order of application of algorithms, the present disclosure addresses systems and methods for prioritizing search results from particular ontology classes. Depending on the context in which a certain term is used, certain ontology classes may be more or less relevant to the classification of that term. Thus, in one advantageous aspect, prior to application of the matcher algorithm to a term, the term is assigned to certain categories of data. Based on this initial classification, the ontology classes are considered and ranked in a different order. The resulting tabulation of results thus reflects more closely the true classification of the term.

According to a first aspect, a method for matching terminology within a document with terminology from a preexisting ontology is disclosed. The method includes: selecting a plurality of matching algorithms to apply to the document from a set of predetermined matching algorithms; establishing rules for application of the selected algorithms, the rules including: (1) a sequence of how many and which algorithms to apply in a hierarchy and (2) a degree of confidence required in order for each algorithm to output a match; applying the matching algorithms to the document; and based on the output of the matching algorithms, tagging the terms in the document with the corresponding terms in the preexisting ontology.

In another implementation according to the first aspect, the applying step comprises applying a minimum of two matching algorithms to each term prior to generating a match.

Optionally, the applying step further comprises: applying a first matching algorithm to the document; if the first matching algorithm identifies a term in the document as corresponding to a first term in the ontology, applying a second matching algorithm to the term; if the second matching algorithm identifies the matching term as corresponding to the same first term, establishing the new term as matched to the term in the ontology, and, if the second matching algorithm does not identify the matching term as corresponding to the same first term, applying one or more additional matching algorithms.

Optionally, the method further includes assigning different confidence scores to an output of the applying step based on how many matching algorithms agree on a match and on the placement of said matching algorithms within the sequence.

In another implementation according to the first aspect, the establishing step includes revising previously established rules by one or more of: adding one or more matching algorithms; subtracting one or more matching algorithms; changing an order of application of one or more matching algorithms; or changing a confidence level required in order for a matching algorithm to output a match.

According to a second aspect, a method for matching terminology within a document with terminology from a preexisting ontology includes: defining categories of terms to be matched; for each category of terms to be matched, setting a list of ontology classes and an order of ontology classes on which to apply matching algorithms; classifying each term to be matched as belonging to a particular category; matching each term to terms within the ontology classes appropriate for the category of ontology classes, to thereby generate a list of potential matches; and ranking the list of potential matches at least partially based on the order of the ontology classes.

In another implementation according to the second aspect, the ontology is an agronomic ontology, and the categories comprise: samples and metadata.

Optionally, the step of setting a list comprises setting a list of ontology classes to consider based on whether the term is classified as metadata or samples, and setting the order of the ontology classes within the list based on whether the term is classified as trial, treatment, or plot level.

According to a third aspect, a computer program product for matching terminology within a document with terminology from a preexisting ontology, includes instructions, that, when executed by a processor, cause performance of the following steps: selecting a plurality of matching algorithms to apply to the document from a set of predetermined matching algorithms; establishing rules for application of the selected algorithms, the rules including: (1) a sequence of how many and which algorithms to apply in a hierarchy and (2) a degree of confidence required in order for each algorithm to output a match; applying the matching algorithms to the document; and based on the output of the matching algorithms, tagging the terms in the document with the corresponding terms in the preexisting ontology.

According to a fourth aspect, a computer program product for matching terminology within a document with terminology from a preexisting ontology, includes instructions, that, when executed by a processor, cause performance of the following steps: defining categories of terms to be matched; for each category of terms to be matched, setting a list of ontology classes and an order of ontology classes on which to apply matching algorithms; classifying each term to be matched as belonging to a particular category; matching each term to terms within the ontology classes appropriate for the category of ontology classes, to thereby generate a list of potential matches; and ranking the list of potential matches at least partially based on the order of the ontology classes.

### BRIEF DESCRIPTION OF THE DRAWINGS

FIG. 1 illustrates a schematic flow diagram for a process of configuring a matching process for an ontology, according to embodiments of the present disclosure;

FIG. 2 illustrates an example of a hierarchy applied for different matching algorithms, according to embodiments of the present disclosure; and

FIG. 3 illustrates a schematic flow diagram for a process of ordering of ontology classes to consider with respect to a new term, according to embodiments of the present disclosure.

### DETAILED DESCRIPTION OF THE INVENTION

The present invention relates to the field of matching ontologies, and more specifically, but not exclusively, to systems and methods for enabling selection from among different matching algorithms and ordering of ontology classes to apply to a text in order to match terms in the text to terms in a preexisting ontology.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The systems and methods described herein are implemented on a computer. The computer may include a memory, which is non-transitory computer-readable medium having instructions stored thereon. The computer may further include a processor configured to execute the instructions to carry out the instructions stored on the memory. The computer may be a local computer, a virtualized computer, and/or a cloud-based computer. The computer may include a plurality of memories and processors configured to operate together in order to perform the calculations described herein. The system may further include a plurality of databases for storing agronomic data, and at least one database management system for accessing the data.

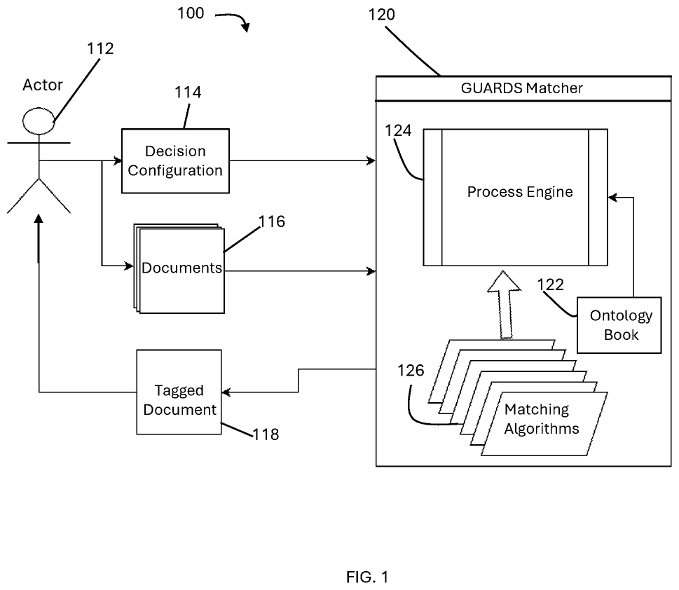

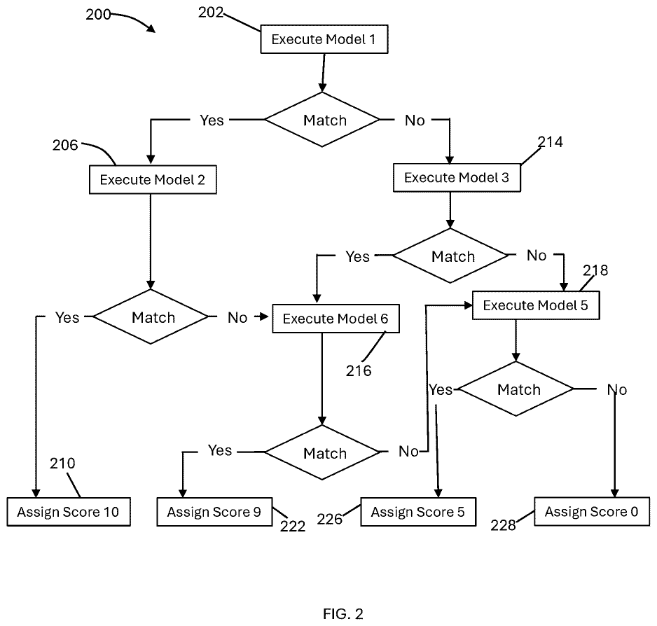

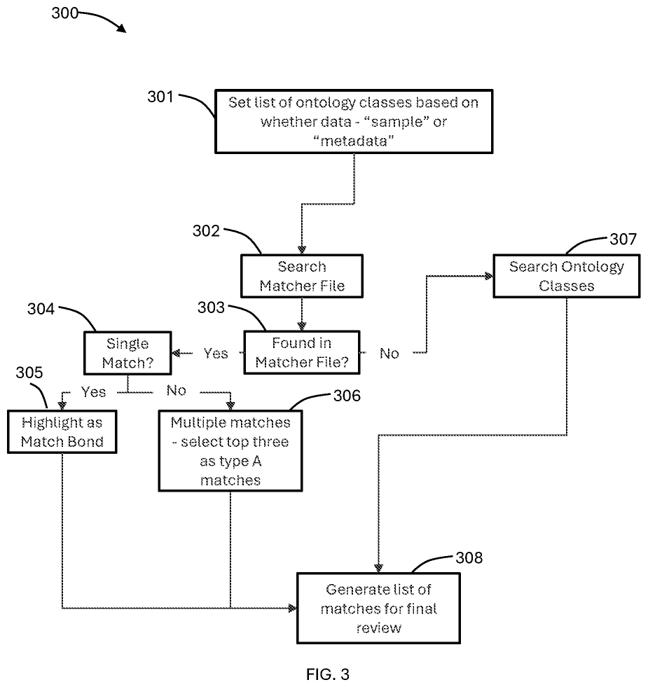

FIG. 1 illustrates a schematic flow diagram 100 for a process of ontology matching, according to embodiments of the present disclosure. The process is controlled by an actor 112. Actor 112 sets a decision configuration 114. The decision configuration 114 is the hierarchy of models, including the ordering of ontology classes, applied to the matching process. One possible example of such a decision configuration 114 is explored in connection with FIG. 2, and another possible example is illustrated in connection with FIG. 3. The user 112 also selects one or more documents 116 containing terminology and data that is required to be matched.

The documents 116 are then sent to a matcher 120. The matcher 120 includes a processor 124, which is configured to perform the various matching algorithms according to the hierarchy set by the user. The matcher 120 also includes a memory that contains a plurality of matching algorithms 126. The matching algorithms are further discussed in connection with FIG. 2. The NLP models are applied, in the desired sequence, to each of the terms in the documents 116. The matcher 120 also includes a database including an ontology book 122. The ontology book refers to the content of the entire ontology, including the hierarchical structure of the terms, and the relationships between these terms as depicted in a knowledge graph.

Following application of the matcher 120 to the documents 116, the matcher 120 outputs a tagged document 118. In the tagged document, each of the agronomic terms is tagged with the corresponding entry of the term in the agronomic ontology. The tagged document may be delivered to the user, or simply stored for future reference, as desired.

FIG. 2 illustrates one possible hierarchy of matching algorithms, according to embodiments of the present disclosure. The hierarchy employs a plurality of different matching algorithms.

The matching algorithms may utilize string similarity metrics. String similarity metrics compare the similarity between strings of words in the text that is being analyzed, as compared to strings of words in the ontology. String similarity metrics may be based on the characters in the string (syntactic), on the meanings of the strings (semantic), or both. Examples of syntactic similarity metrics include Levenshtein Distance, Smith Waterman, Jaro Winkler, Jaccard, TF-IDF, Monge-Elkan, and cosine similarity. Examples of semantic approaches include, for instance, the use of natural language processing, lexicons, translators, and/or domain-specific thesauri. These tools may match words based on linguistic relations (homonymy, synonymy, partonomy, meronyms, subsumptions, etc.) or exploit morphological properties. Regardless of the specific metric that is applied, in order to enable meaningful linguistic comparisons, the contents of strings may be transformed through techniques such as tokenization (parsing phrases into tokens), lemmatization (converting complex words into basic forms), translation, and removal of pronouns and stop words.

The algorithms may include any known ontology matching algorithm. For example, many ontology alignment algorithms are studied in the context of the Ontology Alignment Evaluation Initiative. This initiative considers the performance of alignment algorithms with respect to certain standardized ontology matching problems that are studied over many years, such as in the fields of business, anatomy, and medicine. In addition, the alignment algorithms may be any alignment algorithm that may be developed in the future. In particular, one or more of the ontology matching algorithms may specifically be developed for performance in the space of agronomic ontologies. This is particularly advantageous because different matching algorithms exhibit different degrees of performance based on the type of data entries that they are used to match.

FIG. 2 illustrates one exemplary hierarchy 200 of algorithms that may be applied to a text, according to embodiments of the present disclosure. The illustrated hierarchy proceeds according to a number of matching algorithms, or models, applied sequentially. The logic of the use of the hierarchy proceeds from the reality that different models may produce different outcomes when matching terms.

For example, referring to Table 1 below, the terms “spray volume,” “treatment name,” and “crop name” were input into three different semantic models for ontology matching. Each model assigned the terms to what the model determined to be the closest match in the ontology, and provided the corresponding index within the ontology. In addition, each model assigned a matching score indicating the degree of confidence in the match. Obviously, for entries in which there is an exact, character-for-character match, as in model 1 for “Treatment Name,” the matching score is extremely high. Correspondingly, for matches relying on modification of the text in some manner, including some variation in semantic meaning, the matching score is lower. Each model may have an adjustable scale, which may be set by a user, regarding what is the minimum matching score that is sufficient in order to establish a “match.” In Table 1 below, the matching score has a minimum of 1, and a maximum of 399. Other scales may be used. In the context of FIG. 2, a scale of 1 to 10 is employed. For purposes of the comparison, the relative value of the confidence match for each term is more significant than the absolute value.

TABLE 1
Application of Three Matching Algorithms to Three Agronomic Terms

| | | |
|---|---|---|
| Model 1 | Model 2 | Model 3 |

Spray Volume

| | | | |
|---|---|---|---|
| Closest Match | Application Volume | Application Tank | Application Volume |
| | Per Area | Volume | Description |
| Index | 4.3.2.100 | 4.3.2.107 | 4.3.2.107.3 |
| Score | 36 | 1 | 1 |

Treatment Name

| | | | |
|---|---|---|---|
| Closest Match | Treatment | Treatment Original | Active Ingredient 1 in |
| | Name | Name | Pesticide 1 |
| Index | 1.1.7.3 | 1.1.7.10 | 4.3.1.70.7 |
| Score | 399 | 89 | 23 |

Crop Name

| | | | |
|---|---|---|---|
| Closest Match | Cultivar Specific | Cultivar Scientific | Cultivar Scientific |
| | Name | Name | Name Code |
| Index | 4.1.1.1 | 4.1.1.1.1 | 6.1.12.56 |
| Score | 77 | 60 | 53 |

For the purposes of exemplification of the hierarchical matching method illustrated in FIG. 2, the matching of the term “crop name” is analyzed.

At block 202, model 1 is executed with respect to the term “crop name.” An evaluation is performed whether the output of the model (here, “cultivar specific name”) is deemed a “match” or not. This evaluation may be based on whether the matching score (77) is above the threshold that is set as acceptable for matching.

If the output of the first model 202 is deemed a match, the analysis proceeds to a second model 206. The second model performs the matching analysis. If the second model also produces a match (and the match is the same as the match produced by the first model), then the match is confirmed, and given, at block 210, the highest possible matching score (“matching score 10”). In the example of Table 1, the second model does not produce the same match as the first model. Here, the second model determined that the closest match was “cultivar scientific name.” In such circumstances, then the term is evaluated by a third model (“model 6”) 216. For example, the third model may determine that the best match is “cultivar scientific name code.” If Model 6 produces a match (again, which is consistent with the match generated by the first model), then, at block 222, a matching score is assigned to the match with a high matching score (“matching score 9”). This is a high matching score, because two out of the top three models, as chosen by the user, generated this match. If, however, model 6 does not produce an equivalent match to that of the previous algorithms (as is the case in the example of Table 1), the text is evaluated by a fourth model 218 (“model 5”). If model 5 produces a match, the match is given a matching score, at block 226. This score is merely average (“matching score 5”) because it resulted from at least two results that were not deemed matches. If model 5 does not produce a match, meaning that no match was produced from any of the models, a matching score of zero is assigned, at block 228. In such scenarios, the processor may output that no match was found, and suggest to the actor to either perform the match manually or add the term to the ontology.

Still referring to FIG. 2, if the result of the initial model was not a match, at block 202, the text may be evaluated by another model 214 (“model 3”). If model 3 produces a match, then the analysis may proceed to model 6, at block 216. If model 3 does not produce a match, then the analysis may proceed to model 5, at block 218, as previously described.

Advantageously, and referring back to FIG. 1, actor 112 may arrange the decision configuration 114 in order to best match the context. For purposes of evaluating which decision configuration produces the best results, the actor may determine ground truth for a finite list of terms, and test various combinations and hierarchies of matching algorithms in order to determine which combinations best match ground truth. The ideal combinations and hierarchies may differ based on the context, including but not limited to language of the new document, location in which the data were collected, and specific type of data that is being collected in the new document.

The software program for the decision configuration may enable the rearrangement of the decision tree without requiring any technical capability by actor 112. In other words, all that is necessary for actor 112 is to identify which algorithms to apply and in which order and combinations. The actor 112 may add, subtract, and reorder the algorithms at will.

In the foregoing description, each of the matching algorithms produced a match, albeit with differing degrees of confidence. In alternative scenarios, it is possible that one or more of the matching algorithms does not arrive at a single match with a sufficient degree of confidence to match the predetermined confidence level. Alternatively, two or more matches may be sufficiently close to each other that the matching algorithm is unable to decide between them. In such a case, the matching algorithm may suggest one or more options for the actor 112 to select. The matching algorithm may rank the different options for selection based on, for example, the number of changes necessary to convert between the variable name and the name of the entity in the ontology.

FIG. 3 illustrates steps in a method 300 for tailoring the ontology matching process to the terminology that is being matched, to improve the results of the matching. This introduces context-awareness into the matching process. The approach of FIG. 3 may be applied in lieu of the use of different matching algorithms as described in FIG. 2, or in combination with the process of FIG. 2.

In particular, the process detailed in FIG. 3 addresses performing the matching process using different ordering of ontology classes. As used herein, the term “ontology class” refers to a category or group of things that share common characteristics or properties. For example, in the GUARDS ontology taxonomy, 9 ontology classes or domains are defined: “research definitions,” “soil matrix,” “water,” “inputs and explanatory parameters”, “climate”, “enriched/unique features”, “sampling protocols”, “measurement units” and “outputs”.

The “research definitions” class describes the research ecosystem with its various components, the metadata that governs the other domains, and the external sources of data.

The “soil matrix” class describes the classes and concepts that describe the characteristics of the soil matrix as a medium for growing plants.

The “water” class describes the classes and concepts that describe the characteristics of water used for the cultivation of plants.

The “inputs and explanatory parameters” class describes all classes and concepts that relate to amounts, rates, etc. applied in the trials as explanatory parameters or dynamic parameters, including traits and characteristics of the trial's main object or specimens.

The “climate” class describes the classes and concepts that describe the characteristics of the weather and climate conditions, as dynamic or static parameters that affect the outcome of a trial.

The “enriched/unique features” class refers to metadata or data points that use concepts that are either a projection of other concepts in an enriched capsule (e.g.: “plant maximal height” instead of “plant height”) or concepts that originate from a unique terminology or taxonomy (e.g.: codes for sensors outputs).

The “sampling protocols” class describes test protocols. Test protocols are collections of test cases that evaluate an element or elements of a sample.

The “measurement units” class describes the different units used for the measurement of the quantity of entities in the other domains. A unit of measurement is a definite magnitude of a quantity defined and adopted by convention or by law that is used as a standard for measurement of the same kind of quantity.

The “outputs” class describes all terms that relate to parameters resulting from the inputs of the trial or the explanatory parameters. In the context of an agricultural field trial, an explanatory parameter refers to a variable or factor that is used to explain, influence, or predict the outcome of the trial. These parameters are typically the independent variables in an experiment, meaning they are manipulated or observed to understand their impact on dependent variables, such as crop yield, plant growth, or soil quality.

Examples of explanatory parameters in agricultural field trials are:
1) Soil type or composition
2) Irrigation levels
3) Fertilizer type and application rates
4) Crop variety
5) Pest control methods
6) Weather conditions

These parameters help researchers identify cause-and-effect relationships by linking specific management practices or environmental factors to the outcomes of the trial.

For the remainder of this disclosure, and for purposes of generality, different ontology classes are referred to by different numbers, e.g., 1-9.

One insight upon which method 300 is based is that the specific classification to an ontology class may depend on the context in which the term is used. A priori, any term may be classified as belonging to any particular domain, and indeed, for this reason, it is appropriate to check all terms against all relevant classes. However, depending on the “category” of term that is being matched, it is more likely that the term belongs within certain ontology classes. As a result, certain ontology domains may be weighted higher during the matching process.

Thus, prior to matching, a categorization step is applied, in which the relevant terms to be matched are categorized according to one or more levels. This initial classification may be performed by a human, prior to entry of the terms into the matching program. On a basis of the categorization, a list may be generated regarding both ontology classes to be considered, and the order of ontology classes to be considered within that list.

For agronomic ontologies, the categorization may proceed based on whether the term that is being matched relates to a “sample” or “metadata.” Broadly, “sample” refers to measurements that were taken during an experiment, whereas “metadata” refers to circumstances surrounding the experiment. More specifically, “metadata” is a general name for a group of classes that hold pure metadata parameters (such as names, descriptions, locations etc.) and independent parameters (such as ambient conditions). “Samples” is a general name for a group of classes that hold dependent parameters, namely parameters that are measured or assessed, and they reflect the outcome of the influence of the independent parameters.

One tool for evaluating whether the term is a “sample” or “metadata” is considering whether the data relates to a “trial,” a “treatment,” or a “plot level.” The terms “trial,” “treatment,” and “plot level” refer to three hierarchies of data that may apply to particular experimental results.

“Trial,” as used in this context, refers to fixed circumstances of an agronomic experiment. “Trial” terminology defines circumstances such as conditions of the ground, the type of plant, or the crop that is being examined. “Trial” terminology also refers to units in which the experiment is being conducted, such as a time period or an area of land. For example, if the experiment serves to check the amount of water that is necessary in order to water peach trees in two consecutive seasons, then the term “season” is a “trial” term. However, “trial” terms do not relate to the specific units of data that are measured or the specific units onto which the experiment is applied. “Trial” terms are usually considered to be “metadata.”

“Treatment” classifies the research according to the different treatments, which are intended to validate the effect of the hypothesis on the result that is being examined. For example, when considering the impact of organic versus synthetic fertilizer, a researcher might consider three different “treatments”-organic fertilizer, synthetic fertilizer, and organic and synthetic fertilizer. Each of these terms thus relates to a “treatment.” Data that is classified according to treatments also includes information about the different measurements that are being performed, and the resulting difference in results. For example, when measuring the size of a fruit that is fertilized in one of these ways, both the type of fertilizer that is applied, and the resulting different sizes of the fruits, are considered “treatment” data. “Treatment” terms may sometimes be considered “sample” data and sometimes considered “metadata.”

“Plot level” refers to the different plots to which each “treatment” is applied. For example, in a peach orchard, in which three different treatments are applied, various areas of land are designated “plots.” Different “plots” may have the same “treatments” applied, in order to minimize the incidence and impact of anomalous readings. “Plot level” terms are generally considered “sample” terms.

Generally, for a large, fully-developed experiment, the “trial” and “treatment” information are considered “metadata” and the “plot level” data is considered the “sample.” This is because the “treatment” data is duplicated many times for each experiment, such that the “treatment” does not specifically characterize any given sample. Occasionally, when the experiment is performed in a highly granular manner, the differences in “treatment” are equivalent to differences in “samples.”

In one example, data may be gathered in order to measure the effect of application of a particular fertilizer on grain yield, performed on different plots. In such an example, “plot name” and “trial name” are metadata, describing the plots and the trial, respectively. “Fertilizer application rate” is a “sample” parameter. This “sample” parameter may refer to the trial level, in the case that all plots in the trial had fertilizer applied at the same rate, or it may refer to the plot level, in case each plot in the trial was applied with different rates. “Grain yield” is also a “sample parameter.”. “Grain yield” may refer to the trial level (if the data regarding yield is aggregated with respect to the entire trial, or it may be on the “plot level,” in case the data is measured and reported for the entire plot.

Other initial categorizations of terms may also be useful. For example, “sample” terms may be classified as “independent parameters” or “dependent parameters.” An independent parameter is one that causes an effect over space and time. This effect is quantified or validated through the measurement of dependent parameters, which are affected by the independent parameter. In the example of the previous paragraph, “fertilizer application rate” is an independent parameter, and “grain yield” is a dependent parameter.

As can be readily understood to those of skill in the art, while the specific categories described above are applicable to agronomic data, the process of categorization may be applied to other types of ontologies, with the specific categories being selected on a case-by-case basis. This is particularly the case for ontologies that share the same upper-level organization, such as the Basic Formal Ontology (BFO). Ontologies that are built on this common structure have classes that are categorized and classified using the standard structure, taxonomy and functionality of the BFO, allowing an algorithm to identify the role and the designation of each class. Without limitation, other ontologies for which such classifications may be useful include the Ontology for General Medical Science (OGMS), the Information Artifact Ontology (IAO), the Ontology of Genes and Genomes (IGG), or the Environmental Ontology (ENVO).

In addition, the classes of different ontologies sharing an upper-level organization may be considered when performing the matching process. For example, the term “water layer buildup” may not be in an agronomic ontology. This term, however, may be categorized in the Environmental Ontology. If the term “water layer buildup” is properly classified according to upper layers of the ontology (e.g., as an occurrent, and more specifically, as a process), then the term may be matched to the appropriate class in the ENVO. Thus, the initial categorization enables more reliable matching to classes in different ontologies.

Another principle on which the process of FIG. 3 is based is the assumption that, when a term was previously matched by the matching program, that match is likely to be more correct than any new match generated by the matching program. As a result, the process of FIG. 3 favors preexisting matches. This principle allows for a simpler matching process when preexisting matches are present, as compared to when no preexisting matches are present. A database containing the list of preexisting matches is referred to herein as a “matcher file.”

Referring now to FIG. 3, at step 301, the term to be considered is classified. In the case of agronomic data, the initial classification is either “sample” or “metadata.” Based on the classification of the term as “sample” or “metadata,” different ontology classes are selected for consideration. That is, there may be certain types of ontology classes that are particularly valid for “samples” but not at all relevant for “metadata,” or vice versa. For example, only classes “R,” “SM,” “W,” “I,” “C,” and “E” may be considered for terms related to “metadata,” where classes “R,” “SM,” “W,” “I,” “C,” and “E” denote the ontology classes “research definitions,” “soil matrix,” “water,” “inputs and explanatory parameters”, “climate”, and “enriched/unique features”, respectively, of the GUARDS ontology taxonomy. “R,” “SM,” “W,” “I,” “C,” “E,” and “O” may be considered for terms related to “samples”, where class “O” denotes the ontology class “outputs” of the GUARDS ontology taxonomy.

Within the classification of “metadata,” the terminology is further classified as either “trial,” “treatment,” or “plot” level. The order of the ontology classes that are considered may differ based on this sub-classification. For example, metadata that is “trial” data may have the ontology classes considered in order “R,” “SM,” “W,” “I,” “C,” and “E.” Metadata that is “treatment” or “plot” data may have the classes considered in the order “I,” “R,” “SM,” “W,” “C,” and “E.”

Within the classification of “sample,” the terminology is further classified as either “trial,” “treatment,” or “plot” level. The order of the ontology classes that are considered may differ based on this sub-classification. For example, sample data that is “trial” data may have the ontology classes considered in order “SM,” “W,” “I,” “C,” “E,” “R,” and “O”. Sample data that is “treatment” or “plot” data may have the classes considered in the order “O,” “E,” “W,” “C,” “SM,” “I,” and “R.”

At step 302, the matching program searches the “matcher file” to evaluate, at step 303, whether the term in question has ever been matched before. If yes, then a further evaluation is performed, at step 304, to determine whether the term has been matched previously to only a single term in the ontology or to more than one term in the ontology. If only a single matching term had been previously found, then, at step 305, this match is selected as a “bond” match within the “matcher” level. The “bond” match is designated as “strong” if it had been matched multiple times, and as “weak” if the single match had been used only once. At step 306, if multiple different matching terms in the ontology had previously been applied to the term in question, then the three-highest scoring matches are selected. This is considered a Type A match. The score is measured by the number of times the match is repeated in the matcher file. The score for each match is given by the count of the previous matches between the variable and the ontology concept. For instance in Table 1 the variable “Crop Name” has 77 previous matches with the ontology concept “Cultivar Specific Name” (index 4.1.1.1), hence the score of 77. The output of the GUARDS matcher allows the user to observe the top matches as expressed by the score and choose the most adequate match.

If the term had never been matched before, then, at step 307, the matching process proceeds with comparison to the terms in the ontology classes. Alternatively, the user may configure the matcher program such that comparison to terms in the ontology classes is always performed, even if a match had previously been made for that term.

The program evaluates the matching with respect to the first ontology class. For example, for metadata that is “trial” data, the first ontology class is “R.” In this context, the “first” ontology class refers to the first class for which matching is to be performed, based on the selection of the user, as discussed above. If a single match is output from this matching process, this single match is highlighted as a “class level” bond match and placed onto a list (also called herein a “side list”) of potential matches. If multiple matches are output from this matching process, the top three matches are selected, highlighted as “type B” matches, and placed onto the side list.

Regardless of the results with respect to the first ontology class, the matching process continues for all the ontology classes in the order of ontology classes selected by the user. For example, for metadata that is “trial” data the matching process may continue in the order “SM,” “W,” “I,” “C,” and “E.” The matching process for each one of the subsequent ontology classes is the same as the matching process described herein above for the first ontology class. All the generated matches from the matching process for each ontology class are output to the side list.

For example, for metadata that is “trial” data, regardless of the results for the first ontology class “R”, the matching process continues with the second ontology class “SM.” If a single match is output from this matching process, this single match is highlighted as a “class level” bond match and placed onto the side list of potential matches. If multiple matches are output from this matching process, the top three matches are selected, highlighted as “type B” matches, and placed onto the side list.

Following the matching process of the second ontology class “SM”, the matching process continues with the third ontology class “W.” If a single match is output from this matching process, this single match is highlighted as a “class level” bond match and placed onto the side list of potential matches. If multiple matches are output from this matching process, the top three matches are selected, highlighted as “type B” matches, and placed onto the side list.

Following the matching process of the third ontology class, “W,” the matching process continues with the fourth ontology class “I”. If a single match is output from this matching process, this single match is highlighted as a “class level” bond match and placed onto the side list of potential matches. If multiple matches are output from this matching process, the top three matches are selected, highlighted as “type B” matches, and placed onto the side list.

Following the matching process of the fourth ontology class, “I,” the matching process continues with the fifth ontology class, “C.” If a single match is output from this matching process, this single match is highlighted as a “class level” bond match and placed onto the side list of potential matches. If multiple matches are output from this matching process, the top three matches are selected, highlighted as “type B” matches, and placed onto the side list.

Following the matching process of the fifth ontology class, “C,” the matching process continues with the sixth and final ontology class, “E.” If a single match is output from this matching process, this single match is highlighted as a “class level” bond match and placed onto the side list of potential matches. If multiple matches are output from this matching process, the top three matches are selected, highlighted as “type B” matches, and placed onto the side list.

If no match is found on completion of the matching process for the final ontology class in the order of ontology classes, then an output indicating no match is provided.

At step 308, a final list of matches is generated for the user's review. This step may be reached regardless of the outcomes of each of the previous steps.

In particular, and to summarize the discussion above, when there are previous matches in the matcher file, only those matches may be presented to the user. These matches may be “strong bond” (a single match appearing multiple times), “weak bond” (a single match appearing once), or “Type A” (multiple different matches previously appearing). When all the matches are new matches from the ontology classes (“Type B” or “class bond” matches), then these matches may be presented in an order that is at least partially based on the order of the rankings of the ontology classes as provided by the user. For each ontology class, a single “class bond” match may be presented if, within that class, only a single match is found. If multiple matches are found within a given ontology class, the top three matches (for example) may be presented as “type B” matches.

In some embodiments, the rankings may be strictly stratified based on ontology class (e.g., the results from a first ontology class must always take precedence over results from a second ontology class). Alternatively, the algorithm for the final list may be configured to enable higher ranking matches from lower-ranked ontology classes to obtain a higher final score.

Optionally, the program may select from the side list a limited number of matches for final consideration by the user. For example, only the top three matches may be ultimately presented to the user.

Of course, if, following this entire process, no match is found, then the program may output a status that no match is found.

Reference is now made to Table 2, which is an example of a test dataset applied to the method for matching terminology within a document with terminology from a preexisting ontology (e.g., method 300 described hereinabove). The terms in the test dataset may be categorized by the user (e.g., user 112 in FIG. 1) into the ontology classes of “Trial”, “Treatment” and “Samples” as shown in Table 2.

TABLE 2
An example of a test dataset applied to the method
for matching terminology within a document with
terminology from a preexisting ontology

| Trial | Treatment | Samples |
|---|---|---|
| Research ID | REP | MGHA |
| DOI_publication_0 | ROWS | MOIST |
| DOI_publication_2 | Treatment.1 | OIL |
| Crop_species | kg_N_ha | PRO |
| Crop_cultivar | kg_P_ha | STR |
| Country | kg_K_ha | PH |
| State | kg_S_ha | EH |
| Location | kg_Zn_ha | PD |
| Site | Fungicide | pH_soil |
| GPS_lat_decimal | | CEC_soil |
| GPS_long_decimal | | Organic matter_soil |
| | | % |
| ID | | N %_soil |
| YR | | |
| TRL | | |
| TRIAL | | |

Reference is now made to Tables 3A-3C, which show exemplary results of applying the method for matching terminology within a document with terminology from a preexisting ontology (e.g., method 300 described hereinabove) to terms from the test dataset.

The results show a match to 31 out of 36 terms, with scores ranging from 1 to 754 and an average score of approximately 26 (after excluding outliers). Only one match out of 36 terms is incorrect, namely for the term “ID” in the “Trial” ontology class.

TABLE 3A
Application of the method for matching terminology within
a document with terminology from a preexisting ontology to
terms from the test dataset of the “Trial” ontology class

| | | | |
|---|---|---|---|
| Term | Best Match | Index | Score |

Ontology 1: Trial

| | | | |
|---|---|---|---|
| Research ID | Research ID | 1.1.2.4 | 2 |
| DOI_publication_0 | DOI | 1.2.1.6 | 8 |
| DOI_publication_2 | DOI 2 | 1.2.1.7 | 8 |
| Crop_species | | | |
| Crop_cultivar | Cultivar Specific | 4.1.1.1 | 34 |
| | Name | | |
| Country | Country Name | 2.1.2.1 | 291 |
| State | State Name | 2.1.2.3 | 83 |
| Location | Site Name | 2.1.2.6 | 25 |
| Site | Site Name | 2.1.2.6 | 98 |
| GPS_lat_decimal | Latitude | 2.1.2.10 | 34 |
| GPS_long_decimal | Longitude | 2.1.2.11 | 34 |
| ID | Research ID | 1.1.2.4 | 754 |
| YR | Trial Start Year | 1.1.4.3 | 34 |
| TRL | | | |
| TRIAL | Trial Start Year | 1.1.4.3 | 299 |

Ontology 2: Trial

| | | | |
|---|---|---|---|
| Research ID | | | |
| DOI_publication_0 | | | |
| DOI_publication_2 | | | |
| Crop_species | | | |
| Crop_cultivar | | | |
| Country | | | |
| State | Investigator | 1.2.1.2.11 | 40 |
| | State Name | | |
| Location | Site Address | 2.1.2.6.1 | 7 |
| Site | Trial Type | 1.1.4.1 | 69 |
| GPS_lat_decimal | | | |
| GPS_long_decimal | | | |
| ID | Official trial ID | 1.1.4.14.1 | 196 |
| YR | | | |
| TRL | | | |
| TRIAL | Official trial ID | 1.1.4.14.1 | 196 |

Ontology 3: Trial

| | | | |
|---|---|---|---|
| Research ID | | | |
| DOI_publication_0 | | | |
| DOI_publication_2 | | | |
| Crop_species | | | |
| Crop_cultivar | | | |
| Country | | | |
| State | | | |
| Location | | | |
| Site | | | |
| GPS_lat_decimal | | | |
| GPS_long_decimal | | | |
| ID | Trial Name | 1.1.4.17 | 91 |
| YR | | | |
| TRL | | | |
| TRIAL | Trial End Year | 1.1.4.4 | 175 |

TABLE 3B
Application of the method for matching terminology within a
document with terminology from a preexisting ontology to terms
from the test dataset of the “Treatment” ontology class

| | | | |
|---|---|---|---|
| Term | Best Match | Index | Score |

Ontology 1: Treatment

| | | | |
|---|---|---|---|
| REP | Repetition ID | 1.1.8.1 | 8 |
| ROWS | Number of Plant | 4.4.1.16 | 63 |
| | Rows in Sampled | | |
| | Plot | | |
| Treatment.1 | Treatment Name | 1.1.7.3 | 8 |
| kg_N_ha | Nitrogen Rate of | 4.3.2.1 | 8 |
| | Application | | |
| kg_P_ha | Phosphorus Rate | 4.3.2.4 | 8 |
| | of Application | | |
| kg_K_ha | Potassium Rate of | 4.3.2.5 | 8 |
| | Application | | |
| kg_S_ha | Sulfur Rate Of | 4.3.2.8 | 8 |
| | Application | | |
| kg_Zn_ha | Zinc Rate of | 4.3.2.33 | 8 |
| | Application | | |
| Fungicide | Cultivar | 4.2.1.22 | 1 |
| | Infestation/Disease | | |
| | Name | | |

Ontology 2: Treatment

| | | | |
|---|---|---|---|
| REP | Sample Repetition | 1.1.9.18 | 2 |
| | ID | | |
| ROWS | Length of Spacing | 4.4.1.5 | 14 |
| | Between Rows | | |
| Treatment.1 | | | |
| kg_N_ha | | | |
| kg_P_ha | | | |
| kg_K_ha | | | |
| kg_S_ha | | | |
| kg_Zn_ha | | | |
| Fungicide | First Applied | 4.3.1.7 | 1 |
| | Fungicide Name | | |

Ontology 3: Treatment

| | | | |
|---|---|---|---|
| REP | Plant ID | 1.1.8.1 | 8 |
| ROWS | Row Spacing | 4.4.1.16 | 63 |
| Treatment.1 | | 1.1.7.3 | 8 |
| kg_N_ha | | 4.3.2.1 | 8 |
| kg_P_ha | | 4.3.2.4 | 8 |
| kg_K_ha | | 4.3.2.5 | 8 |
| kg_S_ha | | 4.3.2.8 | 8 |
| kg_Zn_ha | | 4.3.2.33 | 8 |
| Fungicide | | 4.2.1.22 | 1 |

TABLE 3C
Application of the method for matching terminology within a
document with terminology from a preexisting ontology to terms
from the test dataset of the “Samples” ontology class

| | | | |
|---|---|---|---|
| Term | Best Match | Index | Score |

Ontology 1: Samples

| | | | |
|---|---|---|---|
| MGHA | Dry Grain Weight | 9.3.1.12 | 1 |
| | per Area | | |
| MOIST | Grain Moisture | 9.4.1.4 | 1 |
| | Percentage | | |
| OIL | Seed Oil Content | 9.4.1.286.1 | 5 |
| PRO | | | |
| STR | | | |
| PH | Bed Solution pH | 2.2.5.1 | 218 |
| EH | Bed Eh | 2.3.2.13 | 1 |
| | Measurements | | |
| | Protocol Name | | |
| PD | | | |
| pH_soil | Soil pH | 2.2.5.1.6 | 1 |
| CEC_soil | Cation Exchange | 2.2.5.4 | 5 |
| | Capacity (CEC) | | |
| Organic matter_soil | Soil Organic Matter | 2.2.5.38 | 5 |
| % | Percentage | | |
| N %_soil | Soil Nitrogen | 2.2.5.10 | 5 |
| | Content | | |

Ontology 2: Samples

| | | | |
|---|---|---|---|
| MGHA | | | |
| MOIST | Moist Subclass | 6.1.13.76 | 1 |
| OIL | Oil Yield Per Area | 9.3.1.50 | 4 |
| PRO | | | |
| STR | | | |
| PH | | | |
| EH | | | |
| PD | | | |
| pH_soil | | | |
| CEC_soil | | | |
| Organic matter_soil | Soil Organic Matter | 2.2.5.38 | 5 |
| % | Percentage | | |
| N %_soil | Soil Nitrogen | 2.2.5.10 | 5 |
| | Content | | |

Ontology 3: Samples

| | | | |
|---|---|---|---|
| MGHA | | | |
| MOIST | | | |
| OIL | Grain Oil Content | 9.4.1.286 | 4 |
| PRO | | | |
| STR | | | |
| PH | | | |
| EH | | | |
| PD | | | |
| pH_soil | | | |
| CEC_soil | | | |
| Organic matter_soil | | | |
| % | | | |
| N %_soil | | | |

The matching process described herein has numerous advantages compared to known matching processes. First, the application of the ontology classes is set in a default manner so as to maximize the fit of the matches that are applied to each type of term. In addition, similar to the process of FIG. 2, the software program for the decision configuration enables rearrangement of the decision tree without requiring any technical capability by the user. In other words, the user is freely able to identify which of the ontology domains to apply for a given type of term, and in which order and combinations.

What is claimed is:

1. A method for matching terminology within a document with terminology from a preexisting ontology, comprising:
selecting a plurality of matching algorithms to apply to the document from a set of predetermined matching algorithms;
establishing rules for application of the selected algorithms, the rules including: (1) a sequence of how many and which algorithms to apply in a hierarchy and (2) a degree of confidence required in order for each algorithm to output a match;
applying the matching algorithms to the document; and
based on the output of the matching algorithms, tagging the terms in the document with the corresponding terms in the preexisting ontology.

2. The method of claim 1, wherein the applying step comprises applying a minimum of two matching algorithms to each term prior to generating a match.

3. The method of claim 2, wherein the applying step further comprises: applying a first matching algorithm to the document; if the first matching algorithm identifies a term in the document as corresponding to a first term in the ontology, applying a second matching algorithm to the term; if the second matching algorithm identifies the matching term as corresponding to the same first term, establishing the new term as matched to the term in the ontology, and, if the second matching algorithm does not identify the matching term as corresponding to the same first term, applying one or more additional matching algorithms.

4. The method of claim 2, further comprising assigning different confidence scores to an output of the applying step based on how many matching algorithms agree on a match and on the placement of said matching algorithms within the sequence.

5. The method of claim 1, wherein the establishing step comprises revising previously established rules by one or more of: adding one or more matching algorithms; subtracting one or more matching algorithms; changing an order of application of one or more matching algorithms; or changing a confidence level required in order for a matching algorithm to output a match.

6. A method for matching terminology within a document with terminology from a preexisting ontology, comprising:
defining categories of terms to be matched;
for each category of terms to be matched, setting a list of ontology classes and an order of ontology classes on which to apply matching algorithms;
classifying each term to be matched as belonging to a particular category;
matching each term to terms within the ontology classes appropriate for the category of ontology classes, to thereby generate a list of potential matches; and
ranking the list of potential matches at least partially based on the order of the ontology classes.

7. The method of claim 6, wherein the ontology is an agronomic ontology, and the categories comprise: samples and metadata.

8. The method of claim 7, wherein the step of setting a list comprises setting a list of ontology classes to consider based on whether the term is classified as metadata or samples, and setting the order of the ontology classes within the list based on whether the term is classified as trial, treatment, or plot level.

9. A computer program product for matching terminology within a document with terminology from a preexisting ontology, comprising instructions, that, when executed by a processor, cause performance of the following steps:
selecting a plurality of matching algorithms to apply to the document from a set of predetermined matching algorithms;
establishing rules for application of the selected algorithms, the rules including: (1) a sequence of how many and which algorithms to apply in a hierarchy and (2) a degree of confidence required in order for each algorithm to output a match;
applying the matching algorithms to the document; and
based on the output of the matching algorithms, tagging the terms in the document with the corresponding terms in the preexisting ontology.

10. A computer program product for matching terminology within a document with terminology from a preexisting ontology, comprising instructions, that, when executed by a processor, cause performance of the following steps:
defining categories of terms to be matched;
for each category of terms to be matched, setting a list of ontology classes and an order of ontology classes on which to apply matching algorithms;
classifying each term to be matched as belonging to a particular category;
matching each term to terms within the ontology classes appropriate for the category of ontology classes, to thereby generate a list of potential matches; and
ranking the list of potential matches at least partially based on the order of the ontology classes.
